(19) United States
(12) Patent Application Publication
(10) Pub. No.: US 2024/0263507 A1
(43) Pub. Date: Aug. 8, 2024

(54) Actuator Assembly for Moving a Sliding Door or Window

(71) Applicant: Alchin Long Group IP Pty Limited, Wetherill Park (AU)

(72) Inventors: Mitchell Biro, Wetherill Park (AU); Niels Verhaar, Wetherill Park (AU)

(21) Appl. No.: 18/431,390

(22) Filed: Feb. 2, 2024

(30) Foreign Application Priority Data
Feb. 2, 2023 (AU) 2023900252

(51) Int. Cl. E05F 15/652

(52) U.S. Cl. CPC E05F 15/652; E05Y 2201/214; E05Y 2201/22; E05Y 2201/244

(57) ABSTRACT

An actuator assembly (100) for moving a sliding door or window (10), the actuator assembly (100) including: a motor assembly (110) attachable to a frame (20) of the sliding door or window (10); a rod (120) driveable by the motor assembly (110), the rod (120) having a thread (122); a block (130) that is engaged with and driveable by the thread (122) of the rod (120); a connector (150) engaged at a first end (152), with the block (130), and engageable at a second end (154) with the sliding door or window (10), such that actuation of the motor assembly (110) to drive the rod (120) causes movement of the block (130) along the rod (120), which causes movement of the connector (150) for moving the sliding door or window (10).

### RELATED APPLICATIONS

This application claims priority under 35 U.S.C. § 119 or 365 to Australia, Application No. 2023900252, filed Feb. 2, 2023. The entire teachings of the above application(s) are incorporated herein by reference.

### FIELD

The present invention relates to an actuator assembly for moving a sliding door or window.

### BACKGROUND

There is an increasing demand for automation of the opening and closing of windows and doors in dwellings. One reason for this increase in demand is a desire to automate these actions with respect to other information that may be available, another reason is that automation of the closing action can lead to efficiency improvements of the dwelling. However, it is also desirable for the door to remain manually openable/closable, when desired. This is difficult to implement without causing damage to the relevant actuation mechanism.

It is also desirable to provide an automation solution that can be retrofitted.

Existing actuator assemblies typically cannot be drive in reverse by manual use of the door or window, and often require to be installed together with the door or window.

### SUMMARY

It is an object of the present invention to at least substantially address one or more of the above desires, or at least provide a useful alternative to the above-mentioned actuator assemblies.

There is disclosed, in a first aspect, an actuator assembly for moving a sliding door or window, the actuator assembly including:
a motor assembly attachable to a frame of the sliding door or window;
a rod driveable by the motor assembly, the rod having a thread;
a block that is engaged with and driveable by the thread of the rod;
a connector engaged at a first end, with the block, and engageable at a second end with the sliding door or window, such that actuation of the motor assembly to drive the rod causes movement of the block along the rod, which causes movement of the connector for moving the sliding door or window.

Preferably, the connector is selectively engageable with the block.

Preferably, the connector is moveable between a first position, wherein the first end of the connector is engaged with the block such that movement of the block causes movement of the connector, and a second position, wherein the first end of the connector is disengaged with the block such that movement of the block does not cause movement of the connector.

Preferably, the actuator assembly further includes a button assembly operable to move the connector between the first position and the second position.

Preferably, the button assembly includes a slide toggle.

Preferably, the actuator assembly further includes a key lock operable between an unlocked position, wherein the button assembly is operable, and a locked position, wherein the button assembly is not operable.

Preferably, when the key lock is in the locked position, the connector is not moveable between the first position and the second position.

Preferably, the connector is biased toward the first position.

Preferably, in the second position, the connector is moveable relative to the block for moving the sliding door or window without actuation of the motor assembly.

Preferably, the block includes a recess for receiving the connector in the first position.

Preferably, the recess includes chamfered surfaces to guide the connector to the recess when the block collides with the connector in the first position.

Preferably, the movement of the connector between first and second positions is in a connector direction, and wherein the connector is moved perpendicular to the connector direction when guided into the recess by the chamfered surfaces.

Preferably, the actuator assembly further includes a connector holder to allow the connector to engage with the sliding door or window, wherein the connector holder is movable perpendicular to the connector direction between a rest position and a displaced position to allow the movement of the connector when guided into the recess by the chamfered surfaces.

Preferably, the connector holder includes a spring to bias the connector holder toward the rest position.

Preferably, the actuator assembly further includes a tip guide that is removably engaged with the block, wherein the recess is located in the tip guide, and wherein the recess is located off-center with respect to the rod.

Preferably, the actuator assembly further includes a connector holder to allow the connector to engage with the sliding door or window, wherein the connector holder includes a receiver for receiving the connector, the receiver being located off-center with respect to the rod.

Preferably, the connector holder includes at least two receivers, located on opposite off-center locations with respect to the rod.

Preferably, the actuator assembly further includes a tip that is threadingly engaged with the connector, so that a length of the combined connector and tip is adjustable.

There is disclosed, in a second aspect, a sliding door or window assembly including the actuator assembly of the first aspect, the sliding door or window assembly including:
a frame having a sill with jambs upstanding from the sill and topped by a head to define a cavity;
a sliding member mounted in the frame so as to be moveable between an open position and a closed position;
wherein the motor assembly is mounted in an interior of an extrusion profile of at least one of the sill, the jamb, and the head.

Preferably, the assembly further includes a bearing holder at an opposite end of the extrusion profile wherein the motor assembly is mounted, the bearing holder having a bearing to support the rod.

Preferably, the sliding member includes a plurality of sash members, and wherein the connector is mounted in an interior of an extrusion profile of one of the sash members.

Preferably, the button assembly is mounted to one of the sash members.

### BRIEF DESCRIPTION OF THE DRAWING

Preferred embodiments of the present invention will now be described by way of example, with reference to the accompanying drawings, wherein:

FIG. 1 is an exploded view of a sliding door or window assembly including an actuator assembly according to a first embodiment of the invention.

FIG. 2 is a detailed view of the actuator assembly of FIG. 1 with the connector in the first position.

FIG. 3 is a detailed section view of the actuator assembly of FIG. 2.

FIG. 4 is a detailed section view of the actuator assembly of FIG. 1 with the connector in the second position.

FIG. 5 is a detailed section view of the actuator assembly of FIG. 4, with the sliding door or window having been moved relative to the connector.

FIG. 6 is a detailed section view of the actuator assembly of FIG. 5, with the connector in the first position.

FIG. 7 is a detailed isometric view of the button assembly and connector of the actuator assembly of FIG. 4, with the connector in the second position.

FIG. 8 is a detailed isometric view of the button assembly and connector of the actuator assembly of FIG. 4, with the connector in the second position.

FIG. 9 is a detailed isometric view of the button assembly and connector of the actuator assembly of FIG. 2, with the connector in the first position.

FIG. 10 is a detailed isometric view of the button assembly and connector of the actuator assembly of FIG. 2, with the connector in the first position.

FIG. 11 is a cut-away view of the sliding door or window assembly of FIG. 1 with the connector engaged with the block.

FIG. 12 is a cut-away view of the sliding door or window assembly of FIG. 11, with the connector disengaged from the block.

FIG. 13 is an exploded view of a sliding door or window assembly including an actuator assembly according to a second embodiment of the invention.

FIG. 14 is a detailed isometric view of the button assembly of the actuator assembly of FIG. 13 in a first position.

FIG. 15 is a detailed isometric view of the button assembly of FIG. 15 in a second position.

FIG. 16 is a schematic front view of the actuator assembly of FIG. 13 in a first position.

FIG. 17 is a schematic front view of the actuator assembly of FIG. 13 in a second position.

FIG. 18 is an isometric view of the block of the actuator assembly of FIG. 13.

FIG. 19 is a detailed front view of the actuator assembly of FIG. 13.

FIG. 20 is a detailed front view of the actuator assembly of FIG. 13.

FIG. 21 is a detailed front view of the actuator assembly of FIG. 13.

FIG. 22 is a sectioned top view of the actuator assembly of FIG. 19 along line A-A.

FIG. 23 is a sectioned top view of the actuator assembly of FIG. 20 along line B-B.

FIG. 24 is a sectioned top view of the actuator assembly of FIG. 21 along line C-C.

FIG. 25 is a sectioned top view of the actuator assembly of FIG. 19.

FIG. 26 is a sectioned top view of the actuator assembly of FIG. 20.

FIG. 27 is a sectioned top view of the actuator assembly of FIG. 21.

FIG. 28 is an isometric view of a control device of the actuator assembly of FIG. 13 in the keypad mode.

FIG. 29 is an isometric view of the control device of FIG. 28 in door operation mode.

FIG. 30 is a flowchart showing a method according to an embodiment of the invention.

### DETAILED DESCRIPTION

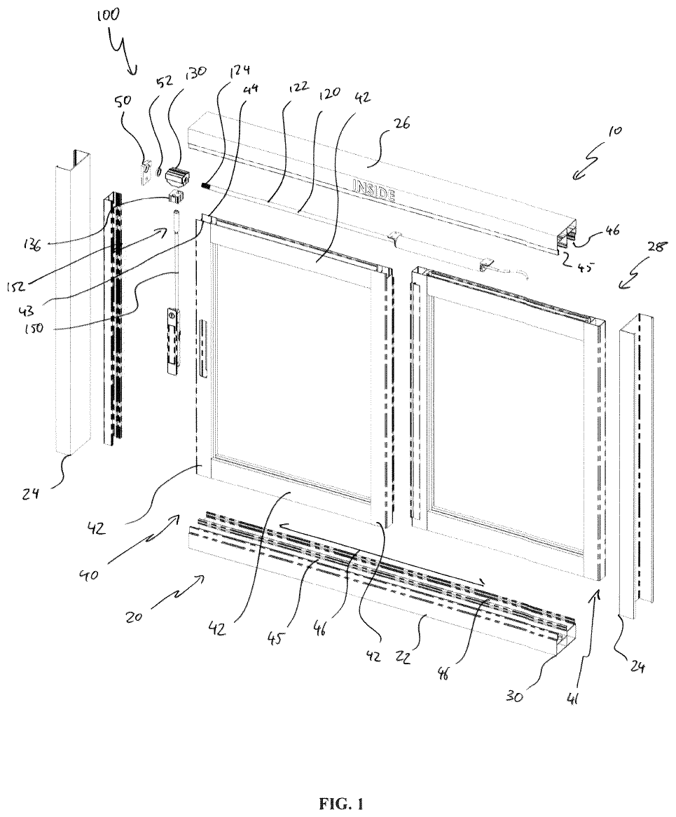

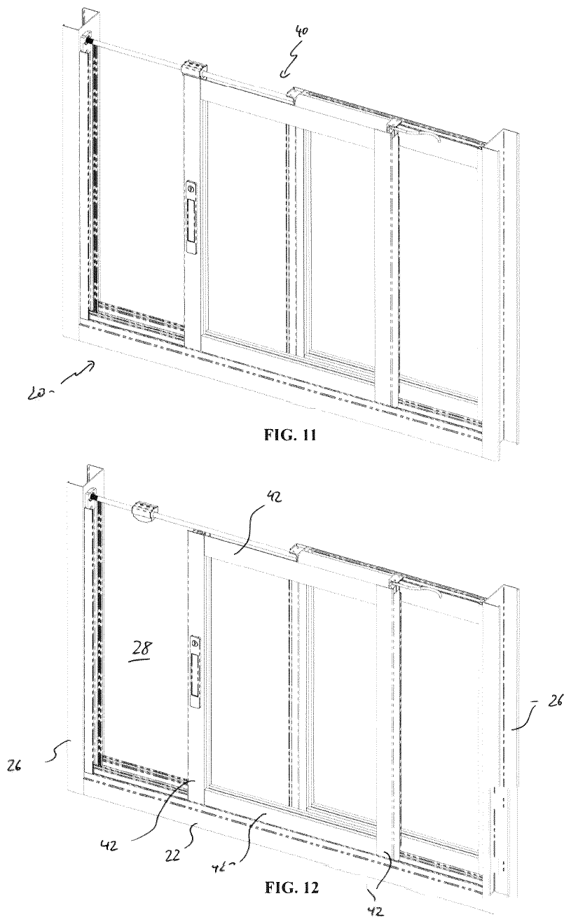

FIG. 1 shows an actuator assembly 100 for moving a sliding door or window assembly 10, according to a preferred embodiment, in the context of the sliding door or window assembly 10. The sliding door or window assembly preferably includes a frame 20 having a sill 22 with jambs 24 upstanding from the sill 22 and topped by a head 26 to define a cavity 28. A sliding member 40 is mounted in the cavity 28 so as to be moveable between an open position (as shown in FIGS. 11 and 12), and a closed position (shown in an exploded view in FIG. 1). The members 22, 24, 26, 28 of the frame 20 are preferably formed according to an extrusion profile 30, respectively, so as to provide lightweight yet stiff components. Preferably, the members 22, 24, 26, 28 are manufactured from aluminium. As shown in FIG. 1, the extrusion profile 30 includes a channel 45 that defines a movement path 46 for the sliding member 40 between the open position and the closed position. In some embodiments, the frame 20 may be provided with a fixed member 41 that is substantially similar to the sliding member 40 but is in a fixed position relative to the frame 20. The fixed member 41 is preferably held in a respective channel 46, substantially similar and parallel to channel 45.

The sliding member 40 preferably includes a plurality of sash members 42. Preferably, each sash member 42 is formed according to an extrusion profile 44. Preferably, the extrusion profile 44 includes a cavity 43, typically used to mount, for example, a window pane (not shown).

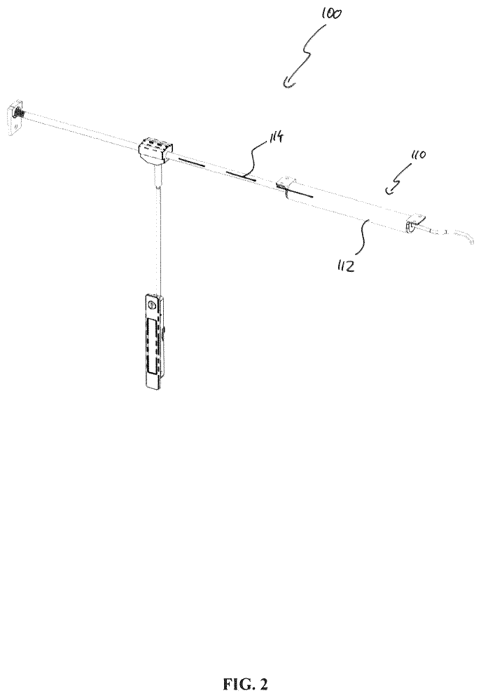

As shown in FIG. 2, the actuator assembly 100 includes a motor assembly 110 that is attachable to a frame 20 of the sliding door or window assembly 10. Preferably the motor assembly 110 is mounted in an interior of the extrusion profile 30 of at least one of the sill 22, the jamb 24, and the head 26. Preferably, the motor assembly 110 is mounted in the channel 45 of the head 26 and/or sill 22. The motor assembly 110 preferably includes a rotary electric motor 112 turning about motor axis 114 and a gearbox (not shown) to provide the required torque characteristics for moving the sliding door or window assembly 10. Preferably, the motor assembly 100 includes a motor controller (not shown) for actuating the motor in response to, for example, a user input device. The user input device may be a button located on the sliding door or window assembly, a button located at a distance from the sliding or window assembly, a command from a scheduled system, or a command from a wireless device in communication with the motor controller.

Moving back to FIG. 1, the actuator assembly 100 further includes a rod 120 that is drivable by the motor assembly 110. The rod 120 has a thread 122 and preferably extends from the motor assembly 110 in the direction of the motor axis 114 and has a length at least as long as a width of the sliding member 40. The sliding door or window assembly 10 includes a bearing holder 50 located at an opposite end of the channel 45 to the motor assembly 110. The bearing holder 50 includes a bearing 52 adapted to receive a free end 124 of the rod 120 to support the rod 120.

Still remaining with FIG. 1, the actuator assembly 100 further includes a block 130 that is engaged with and driveable by the thread 122 of the rod 120. The block 130 is preferably dimensioned to fit within the channel 45 in which the motor assembly 110 and rod 120 are mounted, with a width of the block 130 conforming to an interior width of the extrusion profile 30 of the channel 45, so that rotation of the block 130 about the rod 120 is resisted by the extrusion profile 30. The block 130 preferably has a length along the rod and a height above the rod sufficient such that rotation of block 130 normal to the motor axis 114 and the width, for example caused by tolerances between the thread 122 and the block 130, is resisted by the block 130 abutting an interior ceiling of the extrusion profile 30. Preferably, a top of the block 130 includes a friction reducing material and/or a shock-absorbing material.

As also seen in FIG. 1, the block 130 includes a tip guide 136 that is removably engaged with the block 130. As best seen in FIG. 4, the tip guide 136 includes a recess 132, although the recess 132 could be formed in the block 130. Preferably, the recess 132 is located off-centre with respect to the motor axis 114. The block 130 also includes chamfered surfaces 134 at its forward and rearward leading edges in the direction of the motor axis 114.

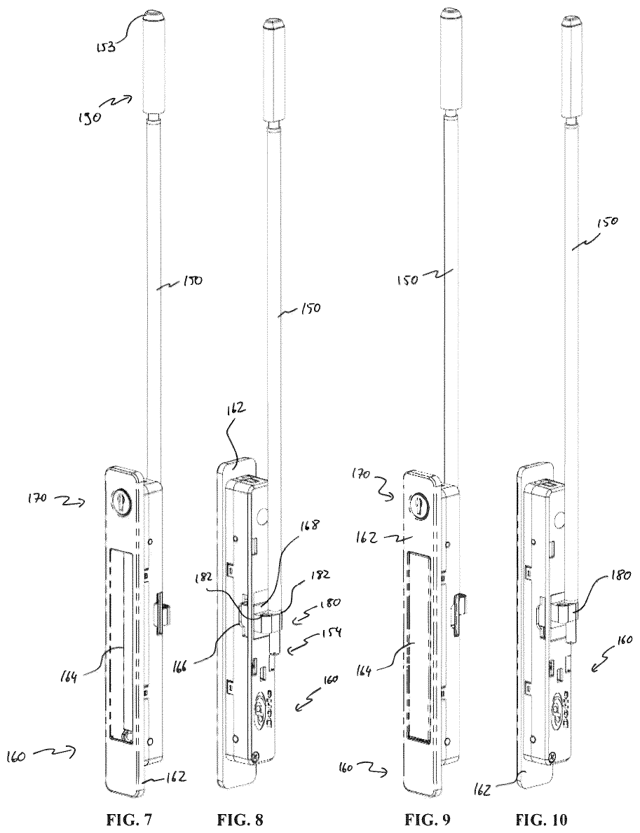

Moving back to FIG. 1, the actuator assembly 100 further includes a connector 150. The connector 150 has a first end 152 that is engaged with the block 130 such that movement of the block 130 causes movement of the connector 150. As seen in FIG. 7, the first end 152 preferably has a chamfered point 153 to be received by the recess 132 of the block 130 to form the engagement. Preferably, the actuator assembly 100 further includes a tip 190 that is threadingly engaged with the connector 150 to form the first end 152 of the connector 150, so that a length of the combined connector 150 and tip 190 is adjustable.

Moving to FIG. 8, the connector 150 has a second end 154 that is engaged with the sliding member 40, such that actuation of the motor 112 to drive the rod 120 causes movement of the block 130 along the rod 120, which causes movement of the connector 150 for moving the sliding member 40.

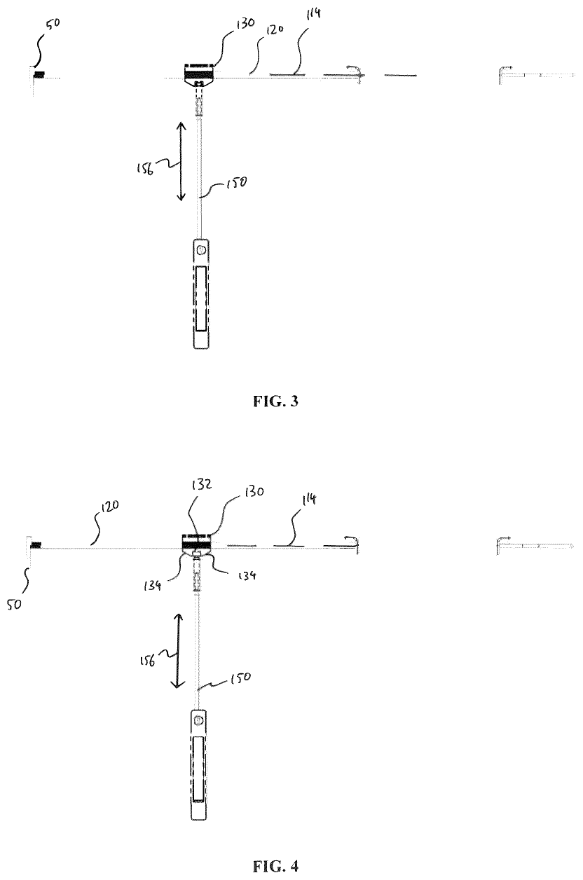

As shown in FIGS. 3 and 4, the connector 150 is selectively engageable with the block 130. In particular, the connector 150 is moveable in a connector direction 156 between a first position shown in FIG. 3, and a second position shown in FIG. 4. Preferably, the connector direction 156 is normal to the motor axis 114. Preferably, the connector 150 is biased toward the first position, for example by means of a spring (not shown). In the first position, the first end 152 of the connector 150 is engaged with the block 130, for example using the recess 132, such that movement of the block 130 causes movement of the connector 150. In the second position, the first end 152 of the connector 150 is disengaged with the block 130 such that movement of the block 130 does not cause movement of the connector 150.

Moving to FIGS. 7 to 10, the actuator assembly 100 further includes a button assembly 160 that is operable to move the connector 150 between the first position, shown in FIGS. 9 and 10, and second position, shown in FIGS. 7 and 8. The button assembly 160 includes a housing 162 adapted to be mounted to one of the sash members 42 such that the connector 150 extends in an interior of the extrusion profile 44 of the sash member 42. Located in the housing 162 is a button 164 that drives a pivoting mechanism 166 to move a receiver mount 168 in the connector direction 156 between the first and second positions, as shown in FIGS. 7 to 10. The actuator assembly 100 further includes a connector holder 180 mounted to the receiver mount 168 of the button assembly 160 to allow the connector 150 to engage the sliding member 40. The connector holder 180 includes a receiver 182 for receiving the second end 154 of the connector 150, such that actuation of the button 164 causes movement of the connector 150 in the connector direction 156. Preferably, the receiver 182 is located off-center with respect to the motor axis 114. Preferably, the connector holder 180 includes at least two receivers 182, located on opposite off-center locations with respect to the motor axis 114.

The actuator assembly 100 further includes a key lock 170, preferably mounted on the button assembly 160. The key lock 170 is operable between an unlocked position, in which the button assembly 160 is operable to move the connector 150 between the first and second position, and a locked position, in which movement of the button assembly 160 to move the connector 150 is blocked.

Use of the actuator assembly 100 with the sliding door and window assembly 10 will now be discussed.

When the connector 150 is engaged with the block 130, as shown in FIG. 3, the sliding member 40 is movable by actuation of the motor assembly 110 in the desired direction to drive the rod 120, to move the block 130 and thereby the connector 150 and sliding member 40. If manual movement of the sliding member 40 is desired, the button 164 of the button assembly 160 is actuated to move the connector 150 to the second position, as shown in FIG. 4. The sliding member 40 may now be moved relative to the block 130, as shown in FIGS. 11 and 12. Once the button 164 is released, the connector 150 is urged back to the first position, as shown in FIG. 6. If the motor assembly 110 is then actuated, the block 130 is driven by the rod 120. When the block 130 collides with the first end 152 of the connector, the chamfered surfaces 134 of the block 130 guide the first end 152 into the recess 132. Once the first end 152 is engaged with the recess 132, the connector 150 then moves together with the block 130, effecting the desired movement of the sliding member 40.

Manual movement of the sliding member 40 may be prohibited by using the key lock 170 to prevent actuation of the button 164, thereby ensuring that the block 130 and connector 150 remain connected and the sliding member 40 is only movable using the motor assembly 110.

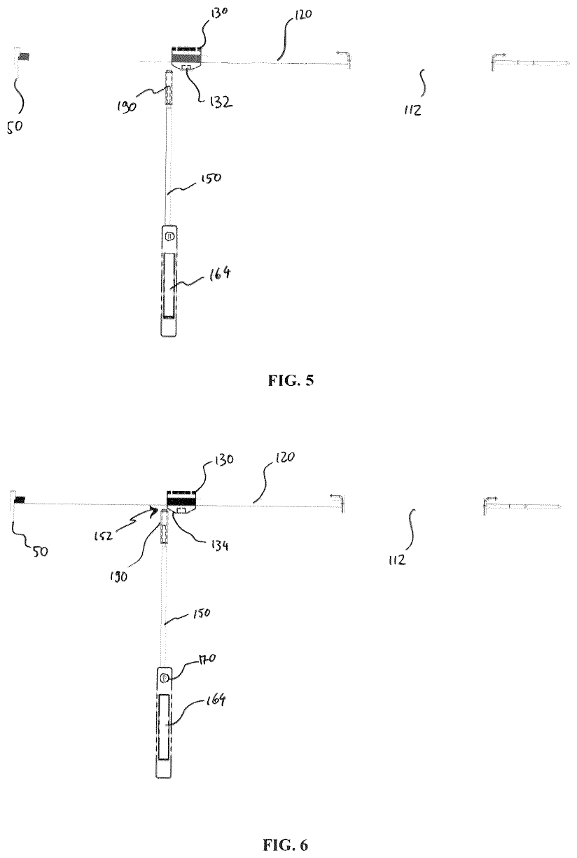

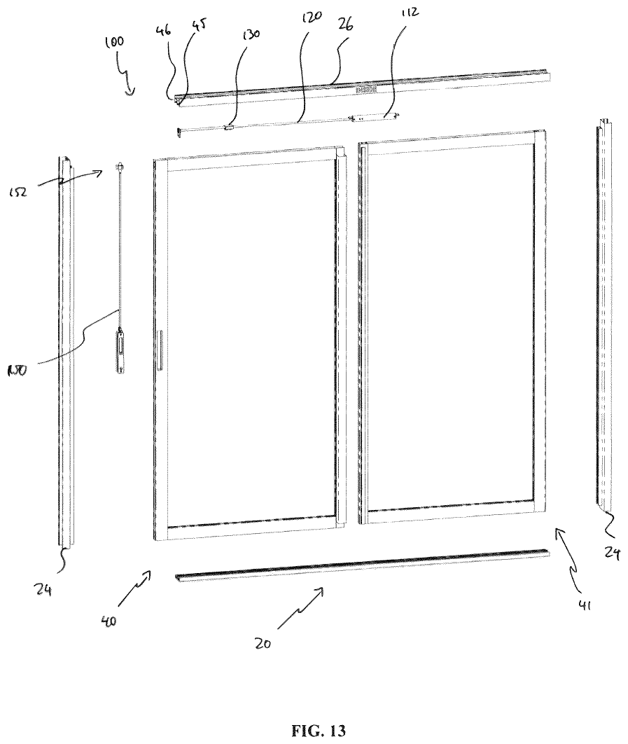

FIGS. 13 to 27 show a second embodiment of the actuator assembly 100 that is substantially similar to the first embodiment disclosed in FIGS. 1 to 12, except for the details discussed below. The actuator assembly 100 of the second embodiment is preferably used for a sliding door assembly 10.

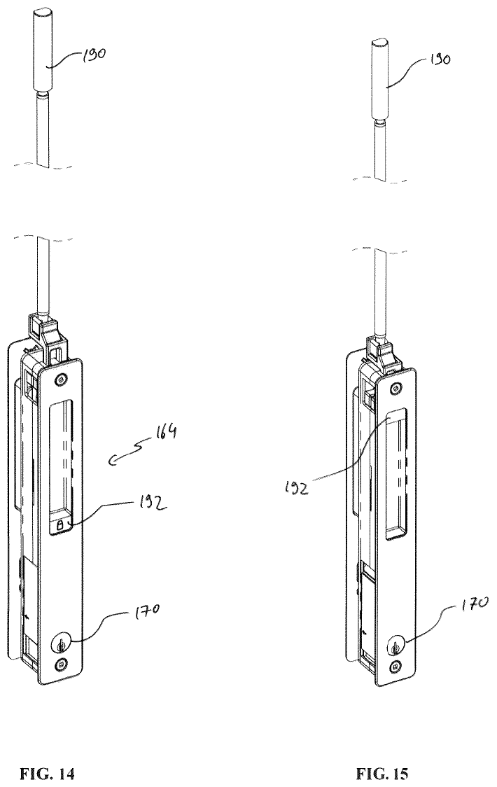

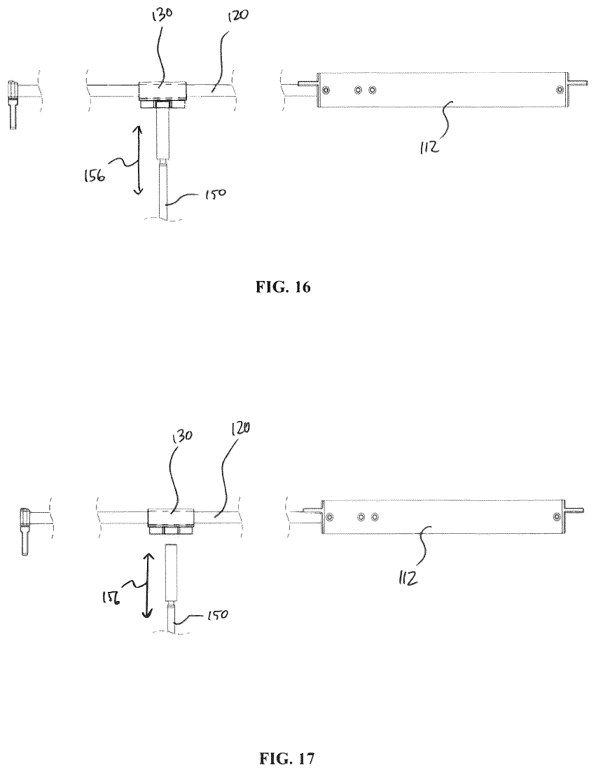

As shown in FIGS. 14 and 15, the button assembly 164 may include a slide toggle 192. As shown in FIGS. 16 and 17, the movement of the connector 150 between the first position, shown in FIG. 16, and the second position, shown in FIG. 17, may be in the connector direction 156. The slide toggle 192 may move the connector 150 between the first position and the second position. In a preferred embodiment, when the key lock 170 is in the locked position, the connector 150 is not movable between the first position and the second position, so that the sliding door assembly 10 may be secured from unauthorized external entry, or unintended engagement of the connector 150 with the recess 132, for example to prevent a user from being locked out of their domicile. The key lock 170 may prevent movement of the connector 150, by preventing movement of the slide toggle 192.

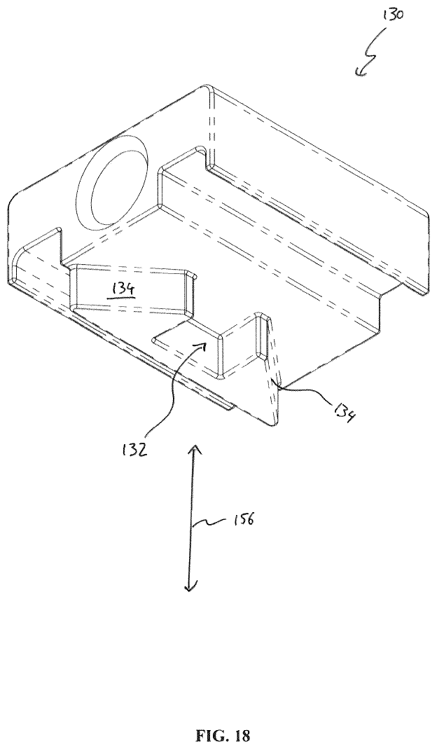

As shown in FIG. 18, the block 130 includes the recess 132, however unlike the first embodiment, where the recess 132 is embodied to extend in the connector direction 156, in the second embodiment the recess 132 extends perpendicular to the connector direction 156. Thus, the permissible movement of the tip 190 to engage in the recess 132 occurs perpendicular to the lock and unlocking movement of the tip 190 in the connector direction 156, allowing the movement of the connector 150 to be more easily locked using the key lock 170, while still allowing the tip 190 to engage the recess 132.

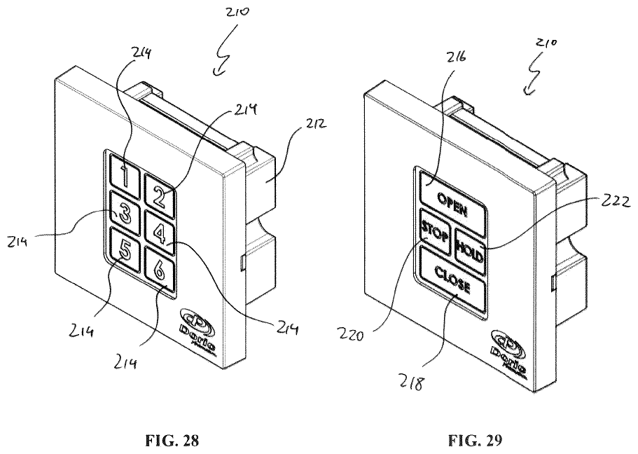

Further, the connector holder 180 may be movable perpendicular to the connector direction 156 between a rest position, shown in FIGS. 25 and 27, and a displaced position, shown in FIG. 26. The connector holder 180 may include a moving block 194 that includes the receiver 182 for the connector 150, which moves along a compliance direction 196 within a cavity 198. The compliance direction 196 is at least partially perpendicular to the connector direction 156. The connector holder 180 further includes one or more springs 200 that urge the moving block 194 toward the rest position.

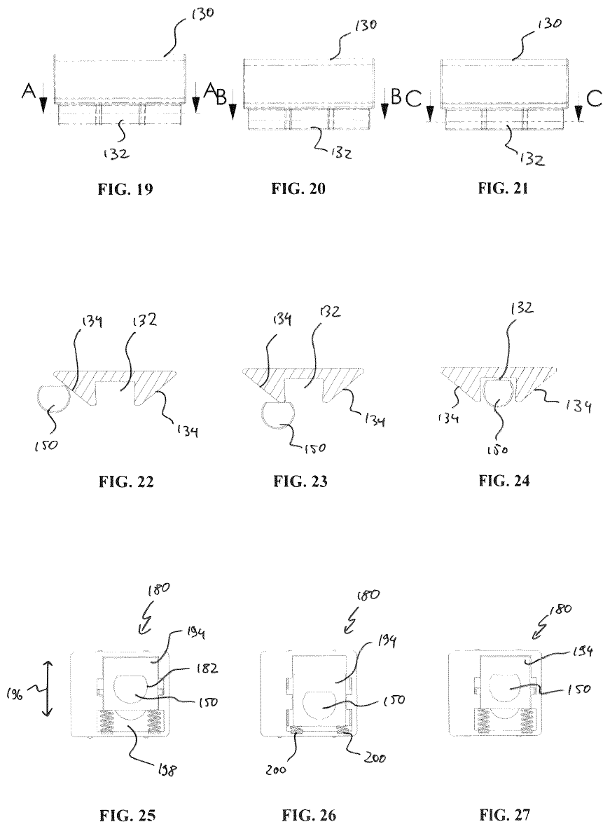

FIGS. 19 to 27 show the sequence of the connector 150 engaging with the recess 132. FIGS. 19, 22, and 25 show the connector 150 prior to engagement with the recess 132, with the moving block 194 in the rest state and the connector 150 contacting the chamfered surfaces 134. As the sliding door assembly 100 is moved toward the position of the block 130, the tip 190 of the connector 150 is urged by the chamfered surface 134 in the compliance direction 196, as shown in FIGS. 20, 23, and 26. Movement of the moving block 194 prevent excessive bending moment from being applied to the connector 150, though lower cost designs may omit the moving block 194 and simply allow the connector 150 to comply with the urging of the chamfered surface 134 in bending. Once the tip 190 has reached the recess 132, the spring 200, or elastic restorative force of the connector 150, urges the tip 190 into engagement with the recess 132. The connector 150 is now engaged with the block 130, and only moves by movement of the block 130.

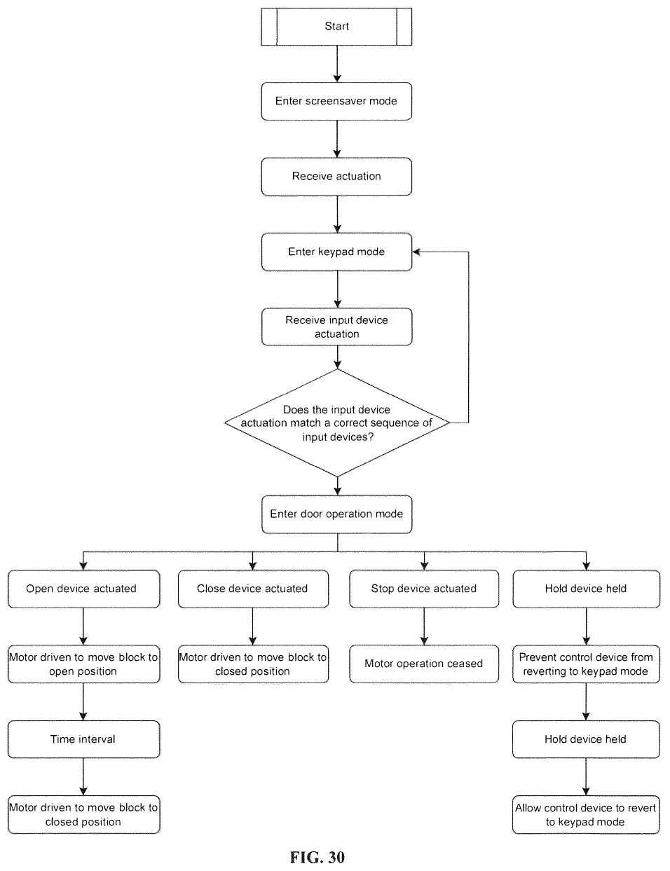

FIGS. 28 and 29 show a control device 210 for operating the actuator assembly 100 according to the method shown in FIG. 30. The control device 210 may include a controller 212. The control device 210 may be a physical keypad, or, as shown in FIG. 28, a touch screen device. The control device 210 may operate in a screensaver mode, a keypad mode, and a door operation mode. In the screensaver mode, the control device 210 may be blank, or show an image. The image may include branding devices. In the screensaver mode, the screen brightness may be adjusted so as to be imperceptible in normal lighting conditions, but to be perceptible in low-light conditions. The screensaver mode may be terminated by interacting with the control device 210, for example by actuating the touch screen device once.

When the screensaver mode is terminated, the control device 210 may enter keypad mode, as shown in FIG. 28. In keypad mode, the control device 210 may display a plurality of input devices 214, such as a T9 number pad, and a correct sequence of input devices must be actuated in order to enter door operation mode. A plurality of correct sequences of input devices may exist. If an incorrect sequence of input devices 214 is actuated, the control device 210 may flash. If an incorrect sequence of input devices 214 is actuated a preset number of times, the control device 210 may reset to a locked screensaver mode that may only be terminated by intervention of a technician.

If a correct sequence of input devices 214 is actuated, the control device 210 may enter door operation mode, as shown in FIG. 29. In door operation mode, the control device 210 may present an open device 216, a close device 218, a stop device 220, and a hold device 222. On activation of the open device 216, the controller 212 operates the motor assembly 100 to move the block 130 towards the open position of the sliding door or window assembly 100. After a time interval, the controller 212 then operates the motor assembly 100 to move the block 130 towards the closed position of the sliding door or window assembly 100. The time interval may be modifiable by the user. On actuation of the stop device 220, the controller 212 causes the motor assembly 110 to stop operation and maintain the sliding door or window assembly 100 in its current position. On actuation of the close device 218, the controller 212 causes the motor assembly 110 to move the block 130 towards the closed position of the sliding door or window assembly 100.

As described above, if the connector 150 is engaged with the block 130, the sliding member 40 will follow movement of the block 130. If the connector 150 is not engaged with the block 130, but is in the first position, movement of the block 130 will eventually intersect the position of the connector 150, at which point the chamfered surfaces 134 will cause the connector 150 to engage the block 130. If the connector 150 is in the second position, for example by operation of the key lock 170, movement of the block 130 will not affect the position of the sliding member 40.

Following a first reset interval without actuation of the control device 210 in the door operation mode, the control device 210 will return to the keypad mode. Following a second reset interval without actuation of the control device 210 in the keypad mode, the control device 210 will return to the screensaver mode. When the control device 210 is in the door operation mode, the hold device 222 may be actuated for a hold interval, such as 2 s. Following successful actuation of the hold device 222, the control device 210 will not return to keypad mode. The hold device 222 may be illuminated after successful actuation. The hold device 222 may be deactivated by a further actuation for the hold interval. The hold device 222 allows operation of the open device 210 and the close device 218 without actuation of the correct sequence of input devices 214 in the keypad mode.

Advantages of the actuator assembly 100 will now be discussed.

Because the sliding member 40 is driven by the threaded rod 120 using the block 130, the driving motion is exceptionally stable and predictable, and tolerant of contaminants in the drive mechanism. The selective engageability of the connector 150 with the block 130 allows manual movement of the sliding member 40 when desired. The use of the key lock 170 allows prevention of the manual movement when desired. The use of the recess 132 creates a secure engagement between the connector 150 and the block 130, while the use of the removable tip guide 136 allows the movement of the recess 132 from one off-center location relative to the motor axis 114 to an opposite side, depending on which side the sliding member 40 is mounted in the frame 20 having multiple channels 45. This also creates a desirable offset between the connector direction 156 and the button 164, used to locate the pivoting mechanism 166 for driving the connector 150. For similar reasons, the connector holder 180 desirably includes the at least two receivers 182 located at corresponding off-center locations.

The use of the tip 190 allows the length of the connector 150 to be finely adjusted to ensure that the first position of the connector 150 forms a good engagement with the recess 132 of the block 130 and the second position of the connector 150 allows movement of the connector 150 relative to the block 130.

Mounting of the motor assembly 110 in the extrusion profile 30 desirably protects the mechanism from dirt and other contaminants, while also desirably hiding the mechanism from view. Similarly, the mounting of the connector 150 in the extrusion profile 44 desirably hides the connector 150 from view and protects the mechanism from dirt and contamination. The use of the bearing holder 50 supports the rod 120 to assist the rod 120 in maintaining a straight line along the motor axis 112.

It should be appreciated that the term connected, when used in the claims, should not be interpreted as being limited to direct connections only. The terms “coupled” and “connected,” along with their derivatives, may be used. It should be understood that these terms are not intended as synonyms for each other. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical contact, or that two or more elements are not in direct contact with each other but yet still co-operate or interact with each other.

### Integers:

| | |
|---|---|
| 10 | sliding door or window assembly |
| 20 | frame |
| 22 | sill |
| 24 | jamb |
| 26 | head |
| 28 | cavity |
| 30 | extrusion profile |
| 40 | sliding member |
| 41 | fixed member. |
| 42 | sash member |
| 43 | cavity |
| 44 | extrusion profile |
| 45 | channel |
| 46 | channel (fixed) |
| 46 | movement path |
| 50 | bearing holder |
| 52 | bearing |
| 100 | actuator assembly |
| 110 | motor assembly |
| 112 | motor |
| 114 | motor axis |
| 120 | rod |
| 122 | thread |
| 124 | free end |
| 130 | block |
| 132 | recess |
| 134 | chamfered surfaces |
| 136 | tip guide |
| 150 | connector |
| 152 | first end |
| 154 | second end |
| 156 | connector direction |
| 160 | button assembly |
| 162 | housing |
| 164 | button |
| 166 | pivoting mechanism |
| 168 | receiver mount |
| 170 | key lock |
| 180 | connector holder |
| 182 | receiver |
| 190 | tip |
| 192 | slide toggle |
| 194 | moving block |
| 196 | compliance direction |
| 198 | cavity |
| 200 | spring |
| 210 | control device |
| 212 | controller |
| 214 | input devices |
| 216 | open device |

1. An actuator assembly for moving a sliding door or window, the actuator assembly including:
a motor assembly attachable to a frame of the sliding door or window;
a rod driveable by the motor assembly, the rod having a thread;
a block that is engaged with and driveable by the thread of the rod;
a connector engaged at a first end, with the block, and engageable at a second end with the sliding door or window, such that actuation of the motor assembly to drive the rod causes movement of the block along the rod, which causes movement of the connector for moving the sliding door or window.

2. The actuator assembly of claim 1, wherein the connector is selectively engageable with the block.

3. The actuator assembly of claim 2, wherein the connector is moveable between a first position, wherein the first end of the connector is engaged with the block such that movement of the block causes movement of the connector, and a second position, wherein the first end of the connector is disengaged with the block such that movement of the block does not cause movement of the connector.

4. The actuator assembly of claim 3, wherein the actuator assembly further includes a button assembly operable to move the connector between the first position and the second position.

5. The actuator assembly of claim 4, wherein the button assembly includes a slide toggle.

6. The actuator assembly of claim 4, wherein the actuator assembly further includes a key lock operable between an unlocked position, wherein the button assembly is operable, and a locked position, wherein the button assembly is not operable.

7. The actuator assembly of claim 6, wherein, when the key lock is in the locked position, the connector is not moveable between the first position and the second position.

8. The actuator assembly of claim 3, wherein the connector is biased toward the first position.

9. The actuator assembly of claim 3, wherein, in the second position, the connector is moveable relative to the block for moving the sliding door or window without actuation of the motor assembly.

10. The actuator assembly of claim 3, wherein the block includes a recess for receiving the connector in the first position.

11. The actuator assembly of claim 10, wherein the recess includes chamfered surfaces to guide the connector to the recess when the block collides with the connector in the first position.

12. The actuator assembly of claim 10, wherein the movement of the connector between first and second positions is in a connector direction, and wherein the connector is moved perpendicular to the connector direction when guided into the recess by the chamfered surfaces.

13. The actuator assembly of claim 12, wherein the actuator assembly further includes a connector holder to allow the connector to engage with the sliding door or window,
wherein the connector holder is movable perpendicular to the connector direction between a rest position and a displaced position to allow the movement of the connector when guided into the recess by the chamfered surfaces.

14. The actuator assembly of claim 13, wherein the connector holder includes a spring to bias the connector holder toward the rest position.

15. The actuator assembly of claim 10, wherein the actuator assembly further includes a tip guide that is removably engaged with the block, wherein the recess is located in the tip guide, and
wherein the recess is located off-center with respect to the rod.

16. The actuator assembly of claim 1, wherein the actuator assembly further includes a connector holder to allow the connector to engage with the sliding door or window,
wherein the connector holder includes a receiver for receiving the connector, the receiver being located off-center with respect to the rod.

17. The actuator assembly of claim 16, wherein the connector holder includes at least two receivers, located on opposite off-center locations with respect to the rod.

18. The actuator assembly of claim 1, wherein the actuator assembly further includes a tip that is threadingly engaged with the connector, so that a length of the combined connector and tip is adjustable.

19. A sliding door or window assembly including the actuator assembly of claim 1, the sliding door or window assembly including:
a frame having a sill with jambs upstanding from the sill and topped by a head to define a cavity;
a sliding member mounted in the frame so as to be moveable between an open position and a closed position;
wherein the motor assembly is mounted in an interior of an extrusion profile of at least one of the sill, the jamb, and the head.

20. The sliding door or window assembly of claim 19, wherein the assembly further includes a bearing holder at an opposite end of the extrusion profile wherein the motor assembly is mounted, the bearing holder having a bearing to support the rod.

21. The sliding door or window assembly of claim 19, wherein the sliding member includes a plurality of sash members, and wherein the connector is mounted in an interior of an extrusion profile of one of the sash members.

22. The sliding door or window assembly of claim 21, wherein the actuator assembly further includes a button assembly operable to move the connector between a first position and a second position and wherein the button assembly is mounted to one of the sash members.
